(19) United States
(12) Patent Application Publication
(10) Pub. No.: US 2026/0340995 A1
(43) Pub. Date: Oct. 29, 2026

(54) IMAGE PROCESSING APPARATUS, IMAGE PROCESSING METHOD, AND RECORDING MEDIUM

(71) Applicant: NEC Corporation, Tokyo (JP)

(72) Inventors: Yasuto NAGASE, Tokyo (JP); Yasunori Babazaki, Tokyo (JP); Toru Takahashi, Tokyo (JP)

(73) Assignee: NEC Corporation, Tokyo (JP)

(21) Appl. No.: 19/645,459

(22) Filed: Apr. 13, 2026

(30) Foreign Application Priority Data
Apr. 28, 2025 (JP) 2025-074404

(51) Int. Cl. G06V 10/77; G06V 10/26

(52) U.S. Cl. CPC G06V 10/7715; G06V 10/26

(57) ABSTRACT

In an image processing apparatus, a text extension unit acquires, based on a text representing an element in an image, an extended text representing an element related to the text. The gaze area extraction unit extracts, as a gaze area, an area in the image including an element similar to the extended text.

### INCORPORATION BY REFERENCE

This application is based upon and claims the benefit of priority from Japanese Patent Application 2025-074404, filed on Apr. 28, 2025, the disclosure of which is incorporated herein in its entirety by reference.

### TECHNICAL FIELD

The present disclosure relates to a technique that can be used to extract features of an image.

### BACKGROUND ART

Techniques that can be used to extract features of an image have been proposed.

Specifically, for example, JP2024-126309A discloses a viewpoint of mapping a text feature associated with text in pair data of the text and an image to a text feature space, mapping an image feature associated with the image of the pair data to an image feature space, generating a plurality of pseudo features associated with the text from the text feature, and mapping the plurality of generated pseudo features to the image feature space.

### SUMMARY

However, according to the technique disclosed in JP2024-126309A, for example, in a case where a plurality of objects respectively associated with a plurality of texts are included in an image, an object having a long distance between features among the plurality of objects can not be extracted as a feature of the image. Therefore, according to the technique disclosed in JP2024-126309A, there is a possibility that an area including a desired element in the image cannot be extracted as a feature portion of the image.

One object of the present disclosure is to provide an image processing apparatus capable of extracting an area including a desired element in an image as a feature portion of the image.

According to one aspect of the present disclosure, an image processing apparatus includes a text extension means configure to acquire, based on a text representing an element in an image, an extended text representing an element related to the text, and a gaze area extraction means configured to extract, as a gaze area, an area in the image including an element similar to the extended text.

According to another aspect of the present disclosure, an image processing method executed by a computer includes acquiring, based on a text representing an element in an image, an extended text representing an element related to the text, and extracting, as a gaze area, an area in the image including an element similar to the extended text.

According to still another aspect of the present disclosure, a recording medium records a program for causing a computer to execute processing of acquiring, based on a text representing an element in an image, an extended text representing an element related to the text, and extracting, as a gaze area, an area in the image including an element similar to the extended text.

According to the present disclosure, it is possible to extract a desired area in an image as a feature portion of the image.

### BRIEF DESCRIPTION OF THE DRAWINGS

FIG. 1 is a diagram illustrating a schematic configuration of an image processing apparatus according to the present disclosure;

FIG. 2 is a block diagram illustrating an example of a hardware configuration of the image processing apparatus according to the present disclosure;

FIG. 3 is a block diagram illustrating an example of a functional configuration of the image processing apparatus according to the present disclosure;

FIG. 4 is a diagram illustrating an example of a mapping result of text features in a feature space;

FIG. 5 is a diagram illustrating an example of a feature vector acquired based on the mapping result of FIG. 4;

FIG. 6 is a diagram for illustrating processing related to similarity calculation;

FIG. 7 is a diagram illustrating an example of a display mode of a gaze area in an image;

FIG. 8 is a flowchart illustrating an example of processing performed in the image processing apparatus according to the present disclosure;

FIG. 9 is a diagram illustrating an example of a monitoring system to which the image processing apparatus according to the present disclosure is applied;

FIG. 10 is a block diagram illustrating another example of a functional configuration of an image processing apparatus according to the present disclosure; and

FIG. 11 is a flowchart illustrating another example of processing performed in the image processing apparatus according to the present disclosure.

### EXAMPLE EMBODIMENTS

Hereinafter, preferred example embodiments of the present disclosure will be described with reference to the drawings.

### System Configuration

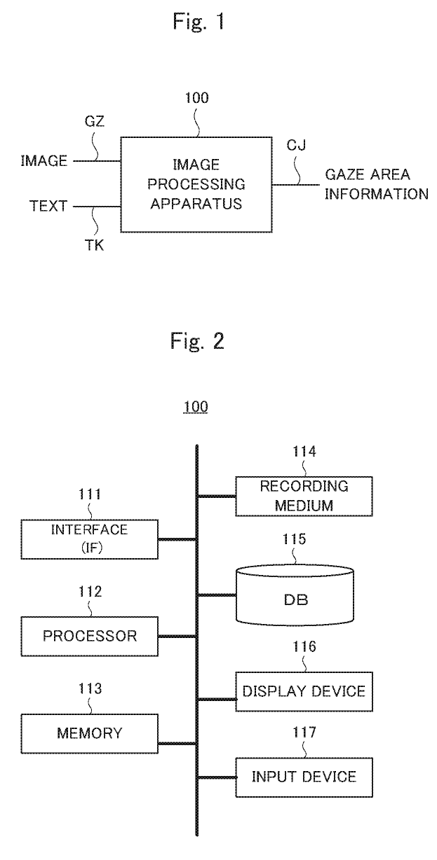

FIG. 1 is a diagram illustrating a schematic configuration of an image processing apparatus according to the present disclosure. An image processing apparatus 100 extracts, by performing processing using an input image GZ and a text TK, a gaze area CR associated with the text TK from the image GZ. In addition, the image processing apparatus 100 acquires gaze area information CJ that is information indicating the gaze area CR in the image GZ, and outputs the acquired gaze area information CJ.

The text TK is a character string representing an element in the image GZ, and is input to the image processing apparatus 100 together with the image GZ. Elements in the image GZ can include, for example, an object, a concept, a situation, a phenomenon, and the like.

The gaze area CR is an area including a desired element in the image GZ, and is extracted as a feature portion of the image GZ by processing to be described later.

By the way, for example, in a model trained by contrastive language-image pre-training (CLIP), an element associated with a text can be extracted from an image based on a distance between a feature of the image and a feature of the text that are mapped to the same feature space. On the other hand, in the model trained by CLIP, there is a case where an element gazed at by a user cannot be extracted from an image due to, for example, a long distance between a feature of the image and a feature of a text. In contrast, the image processing apparatus 100 can extract an area including an element gazed at by a user in an image as a feature portion of the image, by performing processing to be described later.

### Hardware Configuration

FIG. 2 is a block diagram illustrating an example of a hardware configuration of the image processing apparatus according to the present disclosure. As illustrated in FIG. 2, the image processing apparatus 100 includes an interface (IF) 111, a processor 112, a memory 113, a recording medium 114, a database (DB) 115, a display device 116, and an input device 117.

The IF 111 has a function capable of communicating with an external device. The IF 111 receives, for example, data including the image GZ and the text TK.

The processor 112 is a computer such as a central processing unit (CPU), and takes overall control of the image processing apparatus 100 by executing a program prepared in advance. The processor 112 performs, for example, processing related to extraction of the gaze area CR.

The memory 113 includes a read only memory (ROM), a random access memory (RAM), or the like. The memory 113 is also used as a working memory during execution of various types of processing by the processor 112.

The recording medium 114 is a non-volatile non-transitory recording medium, such as a disk-shaped recording medium, a semiconductor memory, and is detachable from the image processing apparatus 100. The recording medium 114 records various programs to be executed by the processor 112. When the image processing apparatus 100 executes the various types of processing, a program recorded in the recording medium 114 is loaded into the memory 113, and is executed by the processor 112.

The DB 115 stores, for example, processing results obtained by processing of the processor 112.

The display device 116 includes, for example, a liquid crystal display. In addition, the display device 116 displays information such as the gaze area information CJ as necessary.

The input device 117 includes, for example, at least one of a keyboard, a mouse, and a touch panel. In addition, the input device 117 instructs the processor 112 in accordance with a user's operation.

### Functional Configuration

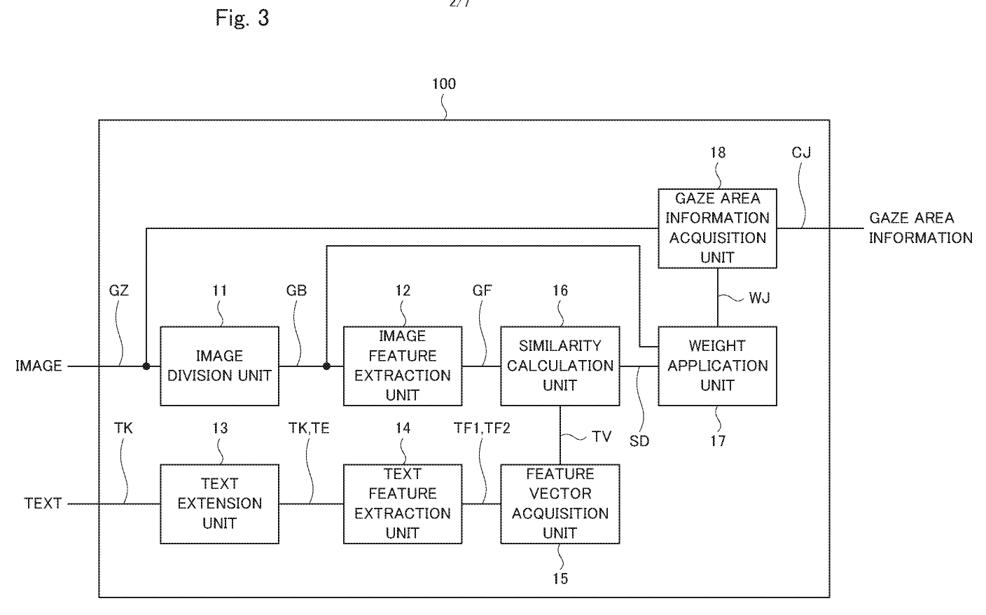

FIG. 3 is a block diagram illustrating an example of a functional configuration of the image processing apparatus according to the present disclosure. As illustrated in FIG. 3, the image processing apparatus 100 includes an image division unit 11, an image feature extraction unit 12, a text extension unit 13, a text feature extraction unit 14, a feature vector acquisition unit 15, a similarity calculation unit 16, a weight application unit 17, and a gaze area information acquisition unit 18.

The image division unit 11 has a function as an image division means. In addition, the image division unit 11 acquires a plurality of partial images GB each having a predetermined size, by dividing the image GZ. Further, the image division unit 11 outputs the plurality of partial images GB to the image feature extraction unit 12 and the weight application unit 17. Note that, in the present disclosure, the “partial image” can be rephrased as a “patch image”.

The image feature extraction unit 12 includes, for example, an image encoder trained by CLIP. In addition, the image feature extraction unit 12 extracts a plurality of image features GF respectively associated with the plurality of partial images GB obtained from the image division unit 11, and outputs the plurality of extracted image features GF to the similarity calculation unit 16.

The text extension unit 13 has a function as a text extension means. In addition, the text extension unit 13 acquires at least one extended text TE based on the text TK. Further, the text extension unit 13 outputs the text TK and the extended text TE to the text feature extraction unit 14.

The extended text TE is acquired as a character string representing an element related to the text TK. Elements related to the text TK can include, for example, an object, a concept, a situation, a phenomenon, and the like.

The text feature extraction unit 14 includes, for example, a text encoder trained by CLIP. In addition, the text feature extraction unit 14 extracts a text feature TF1 associated with the text TK obtained from the text extension unit 13, and outputs the extracted text feature TF1 to the feature vector acquisition unit 15. Further, the text feature extraction unit 14 extracts a text feature TF2 associated with the extended text TE obtained from the text extension unit 13, and outputs the extracted text feature TF2 to the feature vector acquisition unit 15.

The feature vector acquisition unit 15 has a function as a feature vector acquisition means. In addition, the feature vector acquisition unit 15 maps the text feature TF1 and the text feature TF2 obtained from the text feature extraction unit 14 to a feature space SP. Further, the feature vector acquisition unit 15 acquires, based on the mapping result of the text feature TF1 and the text feature TF2 in the feature space SP, a feature vector TV representing a feature of a text group including the text TK and the extended text TE as a vector in the feature space SP. Furthermore, the feature vector acquisition unit 15 outputs the feature vector TV to the similarity calculation unit 16.

The similarity calculation unit 16 has a function as a similarity calculation means. In addition, the similarity calculation unit 16 maps the plurality of image features GF obtained from the image feature extraction unit 12 to the feature space SP. Further, the similarity calculation unit 16 acquires, based on the mapping result of the plurality of image features GF in the feature space SP, a plurality of feature vectors GV each representing a feature of a corresponding one of the plurality of partial images GB as a vector in the feature space SP. Furthermore, the similarity calculation unit 16 calculates a plurality of similarities SD each indicating whether the direction of a corresponding one of the plurality of feature vectors GV is similar to the direction of the feature vector TV obtained from the feature vector acquisition unit 15, and outputs the plurality of calculated similarities SD to the weight application unit 17.

The weight application unit 17 has a function as a weight application means. In addition, the weight application unit 17 sets a weight WT for each of the plurality of partial images GB obtained from the image division unit 11, based on the plurality of similarities SD obtained from the similarity calculation unit 16. Further, the weight application unit 17 calculates a value obtained by multiplying the similarity SD by the weight WT as a calculated value WS for each of the plurality of partial images GB. In other words, the weight application unit 17 calculates the calculated value WS by applying the weight WT to the similarity SD for each of the plurality of partial images GB. Furthermore, the weight application unit 17 outputs weight application information WJ, which is information indicating the calculation result of the plurality of calculated values WS respectively associated with the plurality of partial images GB, to the gaze area information acquisition unit 18.

The gaze area information acquisition unit 18 has a function as a gaze area extraction means. In addition, the gaze area information acquisition unit 18 extracts, as the gaze area CR in the image GZ, an area in which the calculated value WS included in the weight application information WJ obtained from the weight application unit 17 is a predetermined value or more among the plurality of areas respectively associated with the plurality of partial images GB in the image GZ. Further, the gaze area information acquisition unit 18 acquires the gaze area information CJ that is the information indicating the gaze area CR in the image GZ, and outputs the acquired gaze area information CJ. The gaze area information CJ may be stored in the DB 115 or may be displayed on the display device 116, for example.

### Specific Example

Next, a specific example of processing and the like performed in the present disclosure will be described.

Note that, in the present specific example, a description will be given assuming that the text TK including a positive text Tp and a negative text Tn is input to the image processing apparatus 100 unless otherwise specified. The positive text Tp is input to the image processing apparatus 100 as a character string representing an element deemed worthy of gaze by the user or a character string specifying an element to be gazed among the elements included in the image GZ. The negative text Tn is input to the image processing apparatus 100 as a character string representing an element deemed may not be worthy of gaze by the user or a character string specifying an element different from the element to be gazed among the elements included in the image GZ.

The image division unit 11 acquires the M (2 ≤ M) partial images GB each having a predetermined size, by dividing the image GZ. In addition, the image division unit 11 outputs the M partial images GB to the image feature extraction unit 12 and the weight application unit 17.

The image feature extraction unit 12 extracts the M image features GF respectively associated with the M partial images GB, and outputs the extracted M image features GF to the similarity calculation unit 16.

The text extension unit 13 acquires X (1 ≤ X) extended texts TEp based on the positive text Tp included in the text TK.

The text extension unit 13 can acquire the extended text TEp by, for example, inputting the positive text Tp to a trained language model. The language model can include, for example, a model such as large language models (LLM). The text extension unit 13 may acquire the extended text TEp by a method other than the method using the language model.

The text extension unit 13 may acquire the extended text TEp by collecting nouns, adjectives, and the like related to the positive text Tp. Specifically, the text extension unit 13 can acquire the extended text TEp by, for example, extracting a predetermined number of texts in descending order of appearance frequency from a predetermined website including a description regarding the positive text Tp. In addition, the text extension unit 13 can acquire the extended text TEp by, for example, extracting a predetermined number of texts in descending order of appearance frequency from among texts obtained by scraping various websites including the positive text Tp.

The text extension unit 13 can acquire the extended text TEprepresenting, for example, texture, size, position, posture, orientation, material, transparency, pattern, operation, state, quantity, category, temporal element, environment, background, function, application, relationship, and the like as the element related to the positive text Tp.

The extended text TEp representing the texture can include, for example, “smooth”, “rough”, “wood grain”, and the like. The extended text TEp representing the size can include, for example, “huge”, “small”, and the like. The extended text TEp representing the position can include, for example, “center”, “left side”, “background”, and the like. The extended text TEp representing the posture or the orientation can include, for example, “sideways”, “inverted”, and the like. The extended text TEp representing the material can include, for example, “metal”, “plastic”, “cloth”, and the like. The extended text TEp representing the transparency can include, for example, “transparent”, “translucent”, “opaque”, and the like. The extended text TEp representing the pattern can include, for example, “stripe”, “dot pattern”, “check pattern”, and the like. The extended text TEp representing the operation can include, for example, “stationary”, “rotating”, and the like. The extended text TEp representing the state can include, for example, “broken” and the like. The extended text TEp representing the quantity can include, for example, “single”, “plurality of”, and the like. The extended text TEp representing the category can include, for example, “furniture”, “animal”, “vehicle”, and the like. The extended text TEp representing the temporal element can include, for example, “night”, “summer”, “the Middle Ages”, and the like. The extended text TEp representing the environment or the background can include, for example, “outdoor”, “indoor”, “urban environment”, and the like. The extended text TEp representing the function or the application can include, for example, “sports equipment”, “cooking equipment”, and the like. The extended text TEp representing the relationship can include, for example, “riding on top”, “facing”, and the like.

For example, when the positive text Tp is a “compactor”, the text extension unit 13 can acquire character strings such as “construction site”, “plate”, “heavy”, “ground”, and “gravel” as the extended text TEp.

The text extension unit 13 acquires Y (1 ≤ Y) extended texts TEn based on the negative text Tn included in the text TK. For example, the text extension unit 13 can acquire the extended text TEn by using the same method as the method for acquiring the extended text TEp.

The text extension unit 13 outputs the positive text Tp and the X extended texts TEp to the text feature extraction unit 14. In addition, the text extension unit 13 outputs the negative text Tn and the Y extended texts TEn to the text feature extraction unit 14.

The text feature extraction unit 14 extracts a text feature TF1p associated with the positive text Tp and X text features TF2p associated with the X extended texts TEp. In addition, the text feature extraction unit 14 outputs the text feature TF1p and the X text features TF2p to the feature vector acquisition unit 15.

The text feature extraction unit 14 extracts a text feature TF1n associated with the negative text Tn and Y text features TF2n associated with the Y extended texts TEp. In addition, the text feature extraction unit 14 outputs the text feature TF1n and the Y text features TF2n to the feature vector acquisition unit 15.

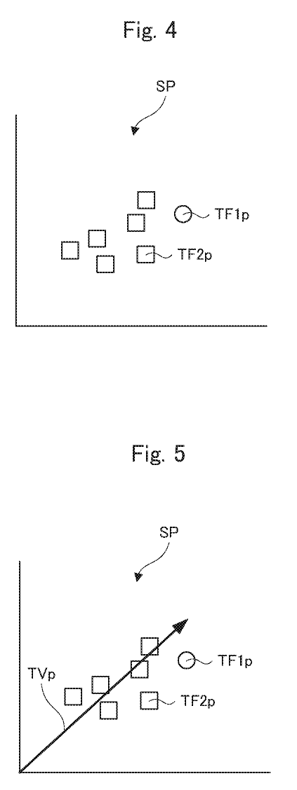

FIG. 4 is a diagram illustrating an example of a mapping result of the text features in the feature space. The feature vector acquisition unit 15 maps the text feature TF1p and the X text features TF2p to the feature space SP. According to such processing, the feature vector acquisition unit 15 can acquire the mapping result as illustrated in FIG. 4 as a mapping result in the case of X = 6, for example.

FIG. 5 is a diagram illustrating an example of a feature vector acquired based on the mapping result of FIG. 4. The feature vector acquisition unit 15 acquires, based on the mapping result of the text feature TF1p and the text features TF2p in the feature space SP, a feature vector TVp representing a feature of a positive text group including the positive text Tp and the extended text TEp as a vector in the feature space SP. Specifically, the feature vector acquisition unit 15 can acquire the feature vector TVp by performing any one of the following processes.

The feature vector acquisition unit 15 can acquire the feature vector TVp by, for example, applying principal component analysis to the mapping result of the text feature TF1p and the text features TF2p. According to such a method, the feature vector acquisition unit 15 can acquire, as the feature vector TVp, a vector indicating a semantic direction of the text feature TF1p and the text features TF2p.

The feature vector acquisition unit 15 can acquire the feature vector TVp by, for example, calculating an average vector corresponding to an arithmetic average of a vector associated with the text feature TF1p and X vectors respectively associated with the X text features TF2p. According to such a method, the feature vector acquisition unit 15 can acquire, as the feature vector TVp, a vector indicating a semantic direction of the text feature TF1p and the text features TF2p.

The feature vector acquisition unit 15 can acquire the feature vector TVp by, for example, calculating a difference vector representing a difference between the vector associated with the text feature TF1p and the X vectors respectively associated with the X text features TF2p. According to such a method, the feature vector acquisition unit 15 can acquire, as the feature vector TVp, a vector indicating a semantic direction of the text feature TF1p and the text features TF2p.

The feature vector acquisition unit 15 can acquire the feature vector TVp by, for example, acquiring a plurality of clusters by clustering the text feature TF1p and the X text features TF2p, and performing calculation using a plurality of vectors respectively associated with the plurality of clusters. According to such a method, the feature vector acquisition unit 15 can acquire, as the feature vector TVp, a vector indicating a semantic direction of the text feature TF1p and the text features TF2p.

The feature vector acquisition unit 15 can acquire the feature vector TVp by, for example, acquiring (X+1) normalized vectors by normalizing the vector associated with the text feature TF1p and the X vectors respectively associated with the X text features TF2p, and performing calculation using the acquired (X+1) normalized vectors. According to such a method, the feature vector acquisition unit 15 can acquire, as the feature vector TVp, a vector indicating a semantic direction of the text feature TF1p and the text features TF2p.

For example, the feature vector acquisition unit 15 can acquire, as the feature vector TVp, a vector that maximizes cosine similarity between the vector associated with the text feature TF1p and the X vectors respectively associated with the X text features TF2p. According to such a method, the feature vector acquisition unit 15 can acquire, as the feature vector TVp, a vector indicating a semantic direction of the text feature TF1p and the text features TF2p.

The feature vector acquisition unit 15 maps the text feature TF1n and the Y text features TF2n to the feature space SP. In addition, the feature vector acquisition unit 15 acquires, based on the mapping result of the text feature TF1n and the text feature TF2n in the feature space SP, a feature vector TVn representing a feature of a negative text group including the negative text Tn and the extended text TEn as a vector in the feature space SP, by performing processing similar to the processing described above. Further, the feature vector acquisition unit 15 outputs the feature vector TVp and the feature vector TVn to the similarity calculation unit 16.

The similarity calculation unit 16 maps the M image features GF to the feature space SP. In addition, the similarity calculation unit 16 acquires the M feature vectors GV based on the mapping result of the M image features GF in the feature space SP.

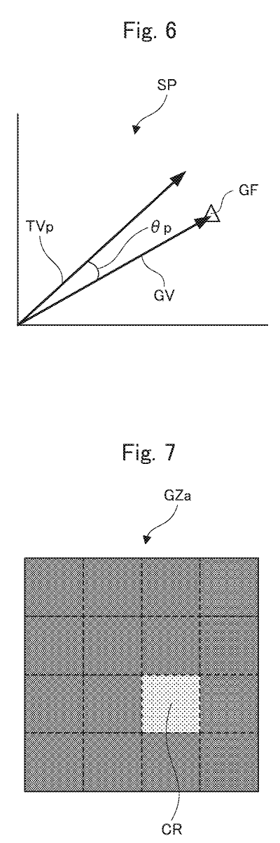

FIG. 6 is a diagram for illustrating processing related to similarity calculation. The similarity calculation unit 16 acquires an angle θp formed by the feature vector TVp and the feature vector GV (see FIG. 6). In addition, the similarity calculation unit 16 calculates cosine similarity associated with the angle θp as a similarity SDp indicating whether the direction of the feature vector GV is similar to the direction of the feature vector TVp. According to such processing, the similarity calculation unit 16 can acquire the M angles θp respectively associated with the directions of the M feature vectors GV, and calculate the cosine similarities respectively associated with the M angles θp as the M similarities SDp. Then, the similarity calculation unit 16 outputs the M similarities SDp to the weight application unit 17.

The similarity calculation unit 16 acquires an angle θn formed by the feature vector TVn and the feature vector GV. In addition, the similarity calculation unit 16 calculates cosine similarity associated with the angle θn as a similarity SDn indicating whether the direction of the feature vector GV is similar to the direction of the feature vector TVn. According to such processing, the similarity calculation unit 16 can acquire the M angles θn respectively associated with the directions of the M feature vectors GV, and calculate the cosine similarities respectively associated with the M angles θn as the M similarities SDn. Then, the similarity calculation unit 16 outputs the M similarities SDn to the weight application unit 17.

The weight application unit 17 sets the weight WT for each of the M partial images GB based on the M similarities SDp and the M similarities SDn.

For example, the weight application unit 17 sets the weight WT of a partial image GBp meeting the condition that the similarity SDp is equal to or greater than a threshold value THp among the M partial images GB to “1”. In addition, the weight application unit 17 sets the weight WT of a partial image GBn meeting the condition that the similarity SDn is equal to or greater than a threshold value THn among the M partial images GB to “0”. For example, the weight application unit 17 can set the weight WT of the partial image GB meeting the condition that the similarity SDp is less than the threshold value THp and the similarity SDn is less than the threshold value THn among the M partial images GB to a value larger than “0” and smaller than “1”. Further, the weight application unit 17 may set the weight WT of the partial image GBp to a value larger than the weight WT of the partial image GBn.

The weight application unit 17 calculates a value obtained by multiplying the similarity SDp by the weight WT as the calculated value WS for each of the M partial images GB. Furthermore, the weight application unit 17 acquires the weight application information WJ, which is information indicating the calculation result of the M calculated values WS respectively associated with the M partial images GB, and outputs the acquired weight application information WJ to the gaze area information acquisition unit 18.

According to the processing described above, the weight application unit 17 can apply a weight WT1 to the similarity SD of the partial image GB including the element represented by the positive text Tp and apply a weight WT2 smaller than the weight WT1 to the similarity SD of the partial image GB including the element represented by the negative text Tn, based on the plurality of partial images GB and the plurality of similarities SD.

The gaze area information acquisition unit 18 extracts, as the gaze area CR in the image GZ, an area in which the calculated value WS included in the weight application information WJ is equal to or larger than the threshold value THp, among the M areas respectively associated with the M partial images GB in the image GZ.

The image processing apparatus 100 can extract the gaze area CR in the image GZ by changing the method for setting the weight WT or the like, for example, even in a case where one of the positive text Tp and the negative text Tn is included in the text TK.

The gaze area information acquisition unit 18 acquires the gaze area information CJ that is the information indicating the gaze area CR in the image GZ. Specifically, the gaze area information acquisition unit 18 acquires the gaze area information CJ including an image obtained by performing one of the following processes on the image GZ.

For example, the gaze area information acquisition unit 18 can acquire the gaze area information CJ including an image in which different colors or patterns are applied between the gaze area CR in the image GZ and the areas other than the gaze area CR in the image GZ. In addition, in such a case, the gaze area information acquisition unit 18 can acquire the gaze area information CJ including an image in a heat map format, for example.

For example, the gaze area information acquisition unit 18 can acquire the gaze area information CJ including an image in which the brightness of the gaze area CR in the image GZ is increased and the brightness of the area other than the gaze area CR in the image GZ is decreased.

For example, the gaze area information acquisition unit 18 can acquire the gaze area information CJ including an image to which a frame indicating the position of the gaze area CR in the image GZ is added.

FIG. 7 is a diagram illustrating an example of a display mode of the gaze area in an image. In FIG. 7, specific elements or contents in the image are omitted for convenience of illustration. According to the processing as described above, the image processing apparatus 100 can cause the display device 116 to display, as an image included in the gaze area information CJ, an image GZa in the display mode as illustrated in FIG. 7, for example. The image GZa corresponds to an image in which different patterns are applied to the gaze area CR in the image GZ and the area other than the gaze area CR in the image GZ by performing the above-described processing in a state where the image GZ is divided into 16 partial images GB. By checking the image GZa displayed in response to the input of the text TK and the image GZ, the user can grasp that the element represented as the positive text Tp included in the text TK is included in the gaze area CR in the image GZ.

According to the processing described above, the gaze area information acquisition unit 18 can extract, as the gaze area CR, the area in the image GZ including the element similar to the extended text TE. In addition, according to the processing described above, the gaze area information acquisition unit 18 can extract the gaze area CR from among the plurality of areas respectively associated with the plurality of partial images GB according to the calculation result of the plurality of similarities SD, and output the gaze area information CJ that is the information indicating the gaze area CR in the image GZ. Further, according to the processing described above, the gaze area information acquisition unit 18 can extract, as the gaze area CR, the area in the image GZ associated with the partial image GB including the element represented by the positive text Tp, based on the result of applying the weight WT to each of the plurality of similarities SD.

### Processing Flow

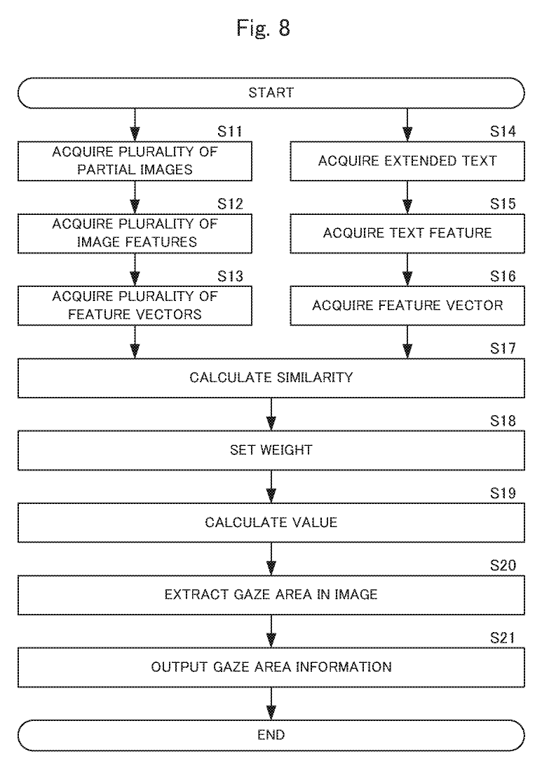

Next, a flow of processing performed in the image processing apparatus 100 will be described. FIG. 8 is a flowchart illustrating an example of processing performed in the image processing apparatus according to the present disclosure.

The image processing apparatus 100 acquires the plurality of partial images GB each having the predetermined size, by dividing the input image GZ (step S11). In addition, the image processing apparatus 100 extracts the plurality of image features GF respectively associated with the plurality of partial images GB (step S12). Further, the image processing apparatus 100 acquires, based on the result of mapping the plurality of image features GF to the feature space SP, the plurality of feature vectors GV each representing the feature of the corresponding one of the plurality of partial images GB as the vector in the feature space SP (step S13).

The image processing apparatus 100 acquires at least one extended text TE based on the input text TK (step S14). In addition, the image processing apparatus 100 extracts the text feature TF1 associated with the text TK and the text feature TF2 associated with the extended text TE (step S15). Further, the image processing apparatus 100 acquires, based on the result of mapping the text feature TF1 and the text feature TF2 to the feature space SP, the feature vector TV representing the feature of the text group including the text TK and the extended text TE as the vector in the feature space SP (step S16).

The image processing apparatus 100 calculates the plurality of similarities SD indicating whether the direction of each of the plurality of feature vectors GV is similar to the direction of the feature vector TV (step S17).

The image processing apparatus 100 sets the weight WT for each of the plurality of partial images GB based on the plurality of similarities SD (step S18). In addition, the image processing apparatus 100 calculates the plurality of calculated values WS respectively associated with the plurality of partial images GB, by applying the weights WT to the similarities SD (step S19).

The image processing apparatus 100 extracts, as the gaze area CR in the image GZ, the area in which the calculated value WS is equal to or larger than the predetermined value, among the plurality of areas respectively associated with the plurality of partial images GB (step S20). In addition, the image processing apparatus 100 acquires the gaze area information CJ that is the information indicating the gaze area CR in the image GZ, and outputs the acquired gaze area information CJ (step S21).

As described above, according to the present example embodiment, for example, by specifying with the text the element in the image deemed worthy of gaze by the user, the area in the image including the specified element can be extracted as the gaze area. In addition, according to the present example embodiment, for example, by specifying with the text the element in the image deemed may not be worthy of gaze by the user, the area in the image including the desired element other than the specified element can be extracted as the gaze area. Therefore, according to the present example embodiment, the area including the desired element in the image can be extracted as the feature portion of the image.

### Application Example

The image processing apparatus of the present disclosure can be applied to, for example, monitoring of a work status of a worker at a construction site or the like. Specifically, the image processing apparatus of the present disclosure can be applied to monitoring of used equipment, clothes, action contents, and the like of a predetermined worker.

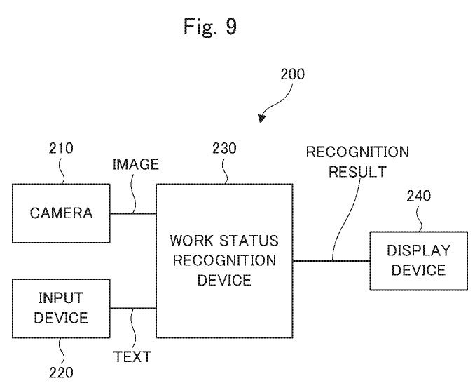

FIG. 9 is a diagram illustrating an example of a monitoring system to which the image processing apparatus according to the present disclosure is applied. A monitoring system 200 includes a camera 210, an input device 220, a work status recognition device 230, and a display device 240.

The camera 210 is installed at a work site to be monitored, captures an image of the work site, and transmits the captured image to the work status recognition device 230.

In response to an operation of a supervisor who monitors the work site, the input device 220 transmits, to the work status recognition device 230, a text representing an element to be gazed such as the used equipment, the clothes, and the action contents of the predetermined worker. For example, when the work site is a construction site, texts including character strings such as “compactor” and “helmet” are transmitted to the work status recognition device 230.

The work status recognition device 230 has a function similar to that of the image processing apparatus 100. In addition, the work status recognition device 230 extracts an area in an image including the element represented by the text as a gaze area, and transmits a recognition result indicating the extracted gaze area to the display device 240.

The display device 240 displays information associated with the recognition result. The supervisor can monitor the work status of the predetermined worker by checking the information displayed on the display device 240.

### Modified Example

Hereinafter, modified examples of the present example embodiment will be described. In the following description, detailed description regarding portions to which previously described processing or the like can be applied will be omitted as appropriate for the sake of simplicity.

### First Modified Example

For example, the image processing apparatus 100 may set a plurality of types of sizes different from each other as sizes for dividing the image GZ, and acquire a plurality of partial image groups respectively associated with the plurality of types of sizes. In addition, in such a case, the image processing apparatus 100 may acquire the gaze area information by, for example, merging extraction results of gaze areas respectively associated with the plurality of partial image groups.

According to the present modified example, for example, the image processing apparatus 100 can acquire the gaze area information including the gaze area merged into one type of size corresponding to the size of the element represented as the positive text included in the text TK among the plurality of types of sizes used for dividing the image GZ.

### Second Modified Example

For example, the image processing apparatus 100 may accumulate the partial image and/or text used when the area including the desired element in the image is extracted as the gaze area in the DB 115 as sample data. In addition, in such a case, the image processing apparatus 100 may perform, based on a feature extracted from the sample data and a feature extracted from an input image, image classification according to the presence or absence of an element of the sample data in the input image, for example.

### Second Example Embodiment

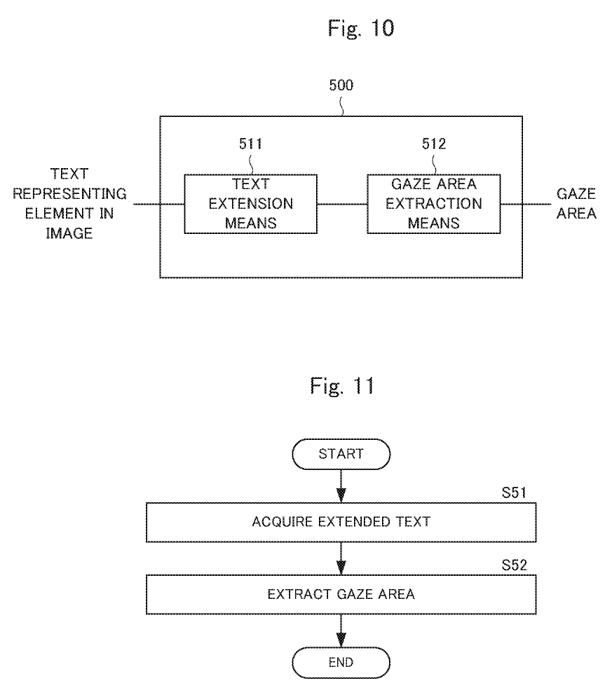

FIG. 10 is a block diagram illustrating another example of a functional configuration of an image processing apparatus according to the present disclosure.

An image processing apparatus 500 has a hardware configuration similar to that of an image processing apparatus 100. In addition, the image processing apparatus 500 includes a text extension means 511 and a gaze area extraction means 512.

The text extension means 511 can be implemented by using, for example, a function of a text extension unit 13. The gaze area extraction means 512 can be implemented by using, for example, a function of a gaze area information acquisition unit 18.

FIG. 11 is a flowchart illustrating another example of processing performed in the image processing apparatus according to the present disclosure.

The text extension means 511 acquires, based on a text representing an element in an image, extended text representing an element related to the text (step S51).

The gaze area extraction means 512 extracts an area in an image including an element similar to the extended text as a gaze area (step S52).

According to the present example embodiment, the area including the desired element in the image can be extracted as a feature portion of the image.

Some or all of the above example embodiments can also be described as the following Supplementary Notes, but are not limited to the following.

### Supplementary Note 1

An image processing apparatus including:
a text extension means configured to acquire, based on a text representing an element in an image,
an extended text representing an element related to the text; and
a gaze area extraction means configured to extract, as a gaze area, an area in the image including an element similar to the extended text.

### Supplementary Note 2

The image processing apparatus according to Supplementary Note 1, further including:
an image division means configured to acquire a plurality of partial images by dividing the image;
a feature vector acquisition means configured to acquire, as a vector in a feature space, a first feature vector representing a feature of a text group including the text and the extended text; and
a similarity calculation means configured to acquire a plurality of second feature vectors each representing a feature of a corresponding one of the plurality of partial images as a vector in the feature space, and calculate a plurality of similarities indicating whether a direction of each of the plurality of second feature vectors is similar to a direction of the first feature vector,
wherein the gaze area extraction means extracts, according to a calculation result of the plurality of similarities, the gaze area from among a plurality of areas respectively associated with the plurality of partial images.

### Supplementary Note 3

The image processing apparatus according to Supplementary Note 2, wherein the text includes at least one of a positive text specifying an element to be gazed among elements included in the image and a negative text specifying an element different from the element to be gazed among the elements included in the image.

### Supplementary Note 4

The image processing apparatus according to Supplementary Note 3, further including a weight application means configured to apply a first weight to a similarity of a first partial image including an element represented by the positive text and apply a second weight smaller than the first weight to a similarity of a second partial image including an element represented by the negative text, based on the plurality of partial images and the plurality of similarities,

wherein the gaze area extraction means extracts an area in the image associated with the first partial image as the gaze area, based on a result of applying a weight to each of the plurality of similarities.

### Supplementary Note 5

The image processing apparatus according to Supplementary Note 1 or 2, wherein the text extension means acquires the extended text by inputting the text to a language model.

### Supplementary Note 6

The image processing apparatus according to Supplementary Note 2, wherein the feature vector acquisition means acquires the first feature vector by applying principal component analysis to a result of mapping a feature associated with the text and a feature associated with the extended text to the feature space.

### Supplementary Note 7

An image processing method executed by a computer, including:
acquiring, based on a text representing an element in an image, an extended text representing an element related to the text; and
extracting, as a gaze area, an area in the image including an element similar to the extended text.

### Supplementary Note 8

A recording medium that records a program for causing a computer to execute processing of:
acquiring, based on a text representing an element in an image, an extended text representing an element related to the text; and
extracting, as a gaze area, an area in the image including an element similar to the extended text.

While the present disclosure has been particularly shown and described with reference to example embodiments thereof, the present disclosure is not limited to these example embodiments and examples. It will be understood by those of ordinary skill in the art that various changes in form and details may be made therein without departing from the spirit and scope of the present disclosure as defined by the claims. And each embodiment can be appropriately combined with other embodiments.

### DESCRIPTION OF SYMBOLS

11 Image division unit
12 Image feature extraction unit
13 Text extension unit
14 Text feature extraction unit
15 Feature vector acquisition unit
16 Similarity calculation unit
17 Weight application unit
18 Gaze area information acquisition unit
100 Image processing apparatus

1. An image processing apparatus comprising:
a memory configured to store instructions; and
one or more processors configured to execute the instructions to:
acquire, based on a text representing an element in an image, an extended text representing an element related to the text; and
extract, as a gaze area, an area in the image including an element similar to the extended text.

2. The image processing apparatus according to claim 1, wherein the one or more processors are further configured to execute the instructions to:
acquire a plurality of partial images by dividing the image;
acquire, as a vector in a feature space, a first feature vector representing a feature of a text group including the text and the extended text; and
acquire a plurality of second feature vectors each representing a feature of a corresponding one of the plurality of partial images as a vector in the feature space, and calculate a plurality of similarities indicating whether a direction of each of the plurality of second feature vectors is similar to a direction of the first feature vector,
wherein the one or more processors extract, according to a calculation result of the plurality of similarities, the gaze area from among a plurality of areas respectively associated with the plurality of partial images.

3. The image processing apparatus according to claim 2, wherein the text includes at least one of a positive text specifying an element to be gazed among elements included in the image and a negative text specifying an element different from the element to be gazed among the elements included in the image.

4. The image processing apparatus according to claim 3, wherein the one or more processors are further configured to execute the instructions to to apply a first weight to a similarity of a first partial image including an element represented by the positive text and apply a second weight smaller than the first weight to a similarity of a second partial image including an element represented by the negative text, based on the plurality of partial images and the plurality of similarities,
wherein the one or more processors extract an area in the image associated with the first partial image as the gaze area, based on a result of applying a weight to each of the plurality of similarities.

5. The image processing apparatus according to claim 1, wherein the one or more processors acquire the extended text by inputting the text to a language model.

6. The image processing apparatus according to claim 2, wherein the one or more processors acquire the first feature vector by applying principal component analysis to a result of mapping a feature associated with the text and a feature associated with the extended text to the feature space.

7. An image processing method executed by a computer, comprising:
acquiring, based on a text representing an element in an image, an extended text representing an element related to the text; and
extracting, as a gaze area, an area in the image including an element similar to the extended text.

8. A non-transitory computer-readable recording medium that records a program for causing a computer to execute processing of:
acquiring, based on a text representing an element in an image, an extended text representing an element related to the text; and
extracting, as a gaze area, an area in the image including an element similar to the extended text.
